(19) United States
(12) Patent Application Publication
(10) Pub. No.: US 2019/0381583 A1
(43) Pub. Date: Dec. 19, 2019

(54) Machine Tool For Dental Purposes And System Comprising Machine Tool And Workpiece

(71) Applicant: Ivoclar Vivadent AG, Schaan (LI)

(72) Inventor: Christoph Farrér, Effretikon (CH)

(21) Appl. No.: 16/481,160

(22) PCT Filed: Jan. 30, 2018
(86) PCT No.: PCT/EP2018/052237

§ 371 Date: Jul. 26, 2019

(30) Foreign Application Priority Data
Jan. 31, 2017 (EP) 17153936.4

(51) Int. Cl. B23C 3/16; B23Q 7/10; B23Q 3/157; B23Q 11/08; B23Q 3/155; A61C 13/00

(52) U.S. Cl. CPC B23C 3/16; B23Q 7/10; B23Q 3/15722; B23Q 2003/155407; B23Q 3/1554; A61C 13/0022; A61C 13/0004; B23Q 11/08

(57) ABSTRACT

The invention relates to a machine tool, in particular a milling machine for dental purposes, with a workpiece magazine for receiving workpieces, optionally with the aid of a housing. The workpiece magazine (22) is also moveably mounted with respect to the machine tool (10) and has a fitting position (30) for fitting a new workpiece (18) in the magazine (22). The machine tool also has a housing (40), in particular a partial housing, for each workpiece (18), the housing at least partially receiving the workpiece (18), and/or has a lifting platform (32), which is arranged adjacent to the fitting position (30) and on which the housing (40) together with the workpiece (18) can be received and displaced. The invention also relates to a system comprising a machine tool and a workpiece.

The invention relates to a machine tool according to the preamble of claim 1, in particular a milling machine for dental workpieces, as well as a system consisting of a machine tool and a workpiece, in particular for a dental workpiece, or a tool according to the preamble of claim 19.

Such machine tools have been known for long.

They typically comprise a workpiece magazine that often is rotatably mounted, the workpieces being arranged adjacent to the outer circumference of the workpiece magazine.

In this respect, the workpieces form a circle within themselves or a pitch circle in the arrangement on the machine tool.

An example of such an arrangement in a dental milling machine can be found in EP 2 387 483 B1.

Such solutions provide the advantage for time-consuming milling processes, for example using dental ceramics, to be able to be previously programmed and to be carried out overnight or on weekends.

The milling blanks, as workpieces, are loaded into the magazine, and the respective blanks are gradually milled and processed to dental restoration parts.

The magazine is preferably loaded at a specific position which is accessible from the outside, or at the most accessible position, the so-called loading position.

In order to process the workpiece, the workpiece magazine is rotated to a specific position, the so-called transfer position, at which position a robot arm or another handling device can take out the workpiece from the magazine, subjecting it to the milling process.

Following completion, the workpiece will typically be returned to the same position in the magazine in the transfer position and the magazine rotates so that the next workpiece may be machined.

New blanks are loaded into the magazine with and, if necessary, the finished workpieces are taken out at the loading position, which is different from the transfer position.

With some workpiece magazines, the magazine wheel may also be taken out as a whole, which, however, is unfavorable if only individual workpieces are to be machined at least partially.

With the well-known workpiece magazines, removal is carried out manually, for example by releasing the holding clamp according to EP 2 387 483 B1, so that the milled final workpiece, in this case in a disc-like shape, may manually be taken out.

Such solutions require the new workpiece to be moved exactly to the desired placement position and the fastening clamps to be operated manually when a new workpiece is to be locked in place.

However, if the operator takes little care while performing this manual handling, the workpiece may accidentally be inserted next to the loading position.

The associated robot arm then cannot grasp the workpiece, or grasps it in an incorrect position, if necessary, so that there is a risk of a milling error to occur.

Dental restoration parts are often milled from composite or ceramic material.

The dental material to be milled at this time is not yet completely hard-sintered, but is available as a relatively soft blank, for example in the form of metasilicate.

Careful handling is advisable, especially for non-sintered, i.e. non-compacted workpieces, as chipping off at corners may result in contaminating the magazine and/or the machine tool.

Moreover, workpiece magazines are sometimes less accessible than with the EP 2 387 483 B1 solution.

In these cases, it is even easier for incorrect handling of the assembly to occur during the loading procedure and, if necessary, also when removing the workpieces.

If, for example, other workpieces are freely accessible to the workpieces in the loading position—and if they are not easily visible—it is easy for confusions to occur, so that a wrong workpiece will be taken out, which then is required to be replaced, possibly resulting in further incorrect handling.

Machine tools in which a tool bank provides a plurality of tools are also known.

Therefore, the object of the invention is to provide a machine tool according to the preamble of claim 1 and a system according to the preamble of claim 19, which are improved in terms of handling and operating without significant additional costs, while simultaneously reducing the probability of maloperation.

According to the invention, this object will be solved by claims 1 and 19. Advantageous other embodiments will arise from the subclaims.

According to one aspect of the invention, it is particularly advantageous for the workpiece and/or the tool to be able to be vertically displaced, if necessary in a housing, to be accessible even if the loading position is not easily accessible even at the workpiece magazine.

The manually operated lifting platform automatically moves the workpiece and/or tool to the correct position in the loading position and can, for example, lock it in place so that it is safely stored in the magazine.

Manual handling and associated errors, such as lateral deviations during insertion, are eliminated. On the other hand, the workpiece or tool may also be moved via the lifting platform to a position where it is easily accessible, i.e. may be taken out or replaced by a new workpiece or tool.

According to another particularly beneficial aspect of the invention, a housing for the workpiece and/or a housing for one or two tools is provided.

Preferably, the housing surrounds the workpiece or the tool(s) in part. It is not required for the housing to be with complete surface filling, so that a frame, for example a merely L-shaped frame, is also to be subsumed herein under the term housing. Or, any other element that extends on 2, 3, 4, 5 or 6 sides of the workpiece should also be subsumed under the term housing.

In any case, it is preferred for the housing to perform a protective function, surrounding the workpiece and/or tool at least at those areas which are sensitive and should therefore be protected.

The housing may be made of folded sheet metal, but it is also possible to provide an appropriate mesh tube frame. The sides of the housing may thus be provided with surface filling, or may be without surface filling or with partial surface filling.

The housing preferably accommodates the workpiece and/or the tool such that it is protected and additionally may safely accommodated be on holding elements of the magazine.

The housing may be designed such that it may be taken out together with the workpiece and/or the tool from the lifting platform and may be inserted thereinto. In one embodiment, it is preferred for part of the workpiece, in particular a holder, and/or the tool, to protrude from the housing.

The holder may then be gripped by a robot arm of the machine tool at the free portion of the holder and taken out from the housing in the transfer position of the workpiece magazine, i.e. in the position in or at which the workpiece may be brought into the milling chamber. The housing then remains empty in the transfer position.

The transfer of a tool also takes place in or at the transfer position. To do this, the magazine is moved—e.g. is rotated—such that the tool to be transferred is located there. The working tip of the tool and a collar that separates the working tip from the shank of the tool protrude from the housing. The magazine is located above the working area, and the working tip and collar extend downwards from the housing.

The robot arm grips the tool at the collar and takes it out from the housing.

If the housing contains two tools, the robot arm takes out the required tool.

The tool housing and the workpiece housing each have lower holding elements that retain the tool or workpiece. They each encompass the collar and preferably have spring-loaded latching tongues which engage in grooves formed on the collar of the workpiece and tool.

In the case of a dental material block glued onto a holder as a workpiece, said grooves may also be formed on the holder at the transition to the block; this area then forms the collar.

Taking out is carried out such that the robot arm, with its chuck, grasps and clamps the holder of the workpiece. It is then pushed sideways out of the housing, if required by overcoming the holding force of latching tongues.

To transfer a tool, a specific gripper is attached to the robot arm. Similar to the holding element, this is U-shaped and thus is open at the side.

The robot arm travels to the transfer position such that the two U-shapes extend transversely to each other. It engages with its gripper in the lower groove of the collar, thus pulling the tool laterally out of the transfer position towards the opening direction of the holding element U.

After swiveling by 180 degrees, the tool is inserted with its shank into the chuck of the tool spindle and is clamped thereto.

In the machine tool, machining takes place, for example via a 5/0 milling machine, i.e. having 5 degrees of freedom for the robot arm and with fixed milling spindle.

After completion of the machining process, the robot arm then returns the finished workpiece into the housing, releasing the holder so that it may be swiveled to the loading position where it may be taken out via the lift platform.

The type of accomodating the workpiece on or in the housing may be adapted to the requirements in a wide range.

For example, the holder, at its end adjacent to the ceramic portion of the workpiece, i.e. the collar, may have a groove arrangement consisting of two opposing grooves.

They may engage with projections of the housing, e.g. webs at which the housing ends and which face towards each other.

The robot arm may then bring the workpiece with its grooves to the height of the webs and insert it laterally into the housing so that it is securely held therein.

In order to improve the accomodating arrangement, the webs may also be provided with latching end tongues which slightly encompass the holder and secure the workpiece in the housing.

Similarly, the same applies to replacement of the tool: The robot arm takes out the tool from the spindle and swivels it 180 degrees.

It then moves the tool to the transfer position, with the shank facing upwards, to deposit it. The magazine is rotated so that the housing including the worn or, in any case, exchangeable tool moves to the loading position.

There, the user may move the lifting platform upwards so that it may grasp the tool housing and move downwards. There, the user takes out the housing from the lift and zo then he takes out the tool to be replaced from the housing.

Another advantage of the housing resides in reduced tendency of workpiece contamination. If the housing has two sides with a surface filling, the user may hold the workpiece including the housing without contacting the workpiece. This may be used, for example, to protect ceramics or other materials sensitive to skin fat from absorbing skin fat.

For the thus desired protective function of the housing, it is only necessary that the housing extends over the useful range of the workpiece. The ceramic body—or any other body—may be mounted, for example, on a holder, in particular by means of an adhesive joint, as it is known per se. The holder is used for mechanical handling and may be designed in any suitable way, for example round, angular or mushroom-shaped. It is designed such that it may easily be grasped by the grippers of a robot arm, so that precise guidance in relative movement between a grinding or milling spindle and the robot arm is possible, and the workpiece may be processed with the desired accuracy of, for example, 10, 20 or 30 micrometers.

According to one embodiment of the invention, it is particularly advantageous for the lifting platform to be designed in combination with a magazine, the accessibility of which is limited or non-existent. Herein, accessibility is to mean accessibility from the outside, i.e. from outside the machine tool, wherein this is always relevant in order to supply the workpieces to the machine tool in the form of blanks or to take them out from the machine tool in the form of finished products or semi-finished products after the workpieces have been machined.

These aspects are particularly relevant for compact machine tools. An example thereof is the so-called “Chairside” milling machine, which is used in dental practices.

According to the invention, it is preferred for such a compact milling machine to have a spindle motor and a spindle which is mounted relatively far below. The main weight of zo the milling machine is then in the lower range, which promotes stability. According to the invention, the workpiece or tool magazine then is conveniently located on the opposite side of the machining area, i.e. on top.

According to the invention, it is also advantageous for the workpieces and tools to be stored in a suspended position in the magazine. Suspended storage means, on the one hand, that at least part of the workpiece and tool is suspended from the plane of the magazine such that it may be grasped, for example by the robot arm for handling the workpiece and the tool, or may be grasped by another gripper. Preferably, a holder of the workpiece protrudes from the workpiece magazine, at least in the so-called transfer position, and may thus be grasped by the clamping jaws of the robot arm. On the other hand, a housing of the workpiece or the workpiece itself may be suspended from the magazine. The tool may also be stored suspended to protrude from the housing, preferably such that the working tip protrudes from the housing.

In this respect, it is advantageous for the workpieces to be arranged in the suspended position in the loading position. The free space then typically extends hidden downwards, at least when a side door or side access is provided to the loading area. The loading area is difficult to see, at least if the machine tool or milling machine as a whole is below eye level, which is typically the case with small milling machines.

According to the invention, a lifting platform is provided for smooth loading and taking out, which moves the workpiece into the loading position in the workpiece magazine and takes out a finished workpiece therefrom. This also applies analogously to tools.

The lifting platform may be moved vertically from the upper position, which is close to the loading position of the workpiece, to a lower position, and back again.

According to the invention, in the lower position, the workpiece and the tool are then freely accessible and easy to take out. Also a new workpiece may easily be supplied thereto.

A suspended arrangement of the workpiece and tool in particular means that the workpiece or tool, which favorably is surrounded by a housing, is suspended by means of this housing. Suspension may be effected by means of one or more holding elements provided in each position of the magazine, into which latching tongues or other suitable fastening elements of the housing—or of the workpiece or tool, as required—may engage.

In a preferred embodiment, the latching tongues may be formed on a stop web, i.e. a web facing upwards, of the housing, which web centrally extends from the front to the rear and has the retaining tongues formed therein.

It is to be understood that any other type of storing of the housing—or of the workpiece or tool—in the workpiece magazine is possible without departing from the scope of the invention, wherein a snap-in or latching connection is preferred.

Such a connection allows the lifting platform to move the housing including the workpiece or tool to the upper position, and when the lifting platform is lowered, the housing including the workpiece or tool remains suspended at the top and can be transported further.

In another advantageous embodiment, the magazine provides seats for the reception of tools and for workpieces. The tools can also be mounted on equivalent partial housings, wherein suspension may be realized via webs at the top of the housings and corresponding latching tongues similar to those described above for the workpiece housings. The tools may also have grooves in which protrusions or tongues of the housings may engage with their lower end to store the tools. Herein too, the tools may be taken out at a transfer position via a corresponding U-shaped gripper on the robot arm.

In an advantageous embodiment, two grooves one being on top of the other are then zo provided on each tool, the upper groove being for the engagement of the spring tongues of the housing, and the lower groove for the engagement of gripping clamps of the robot arm. After taking out from the relevant tool housing, the tool may then be fed via the robot arm to the chuck of the spindle.

According to the invention, it is particularly advantageous for the workpieces, despite suspended storage in the workpiece magazine, not to hit each other, even during rapid rotation of the workpiece magazine, as they are protectively stored in their respective housings. Moreover, the tools cannot be knocked out from the side of their holders in the form of the latching tongues of the housings by knocking, because they are also protectively accommodated in the housings, at least as required.

According to the invention, it is advantageous to implement the workpiece magazine in the form of a sub-circle, i.e. using for example a circular arc of 90°. It is rather be understood, that any other shape of the workpiece magazine may be realized without departing from the scope of the invention, for example a full circle shape, a circular segment shape, an arc shape, an oval shape or even a straight shape. Even a known circulating workpiece magazine with two or more longitudinal sides is not excluded according to the invention.

Even though additional insertion of tools into the workpiece magazine is described herein according to the preferred embodiment, it is to be understood that a pure workpiece magazine should not be excluded instead. In a modified embodiment of the invention, a pure tool magazine is provided instead of the workpiece magazine, and loading and feeding the respective tool magazine is then carried out correspondingly, as described for the workpiece magazine.

According to the invention, it is particularly advantageous for the direction of movement of the lift or lifting platform to be transversal to the direction of movement of the magazine. This enables selective control of the desired position and to take out the workpiece from this location or to convey the workpiece to this location.

The lifting platform may be moved both mechanically and manually. A hydraulic or pneumatic cylinder or a corresponding electric motor, for example, may be used for automatic machine movement. In contrast, manual movability of the lifting platform is preferred. For this purpose, a transversely extending grip handle may be provided, via which the user raises and lowers the lift platform. It is preferred for the direction of movement to be vertical, wherein it is to be understood that an essentially vertical movement may also be included herein. Herein, “essentially” means a deviation of 5, 10 or even 20 degrees or percent from the vertical direction.

It is also particularly advantageous for loading and taking out the workpieces into or of the magazine to always take place at the same locations. loading is done via the loading position. The magazine is turned into the transfer position with the respective workpiece or tool, wherefrom the workpiece or tool is taken out from the housing by the robot arm.

After machining the workpiece or wear of the tool, the workpiece or tool is pushed back into the housing, again at the transfer position, and the magazine is swiveled back.

The final workpiece then reaches the loading position, where the workpiece may be taken out from the lifting platform in a finished machined state.

Due to unequivocal conveying and movement paths of the workpiece within the milling machine there are little error tolerances and precise production; for example, the robot arm may then grasp the holder of the workpiece from workpiece to workpiece at the same location.

The workpiece may be stored in the housing in any suitable manner. Preferably, loading the workpiece into the housing and taking out the workpiece of the housing is done laterally, i.e. in the horizontal direction. This may easily be achieved by the use of a robot arm, and the dead weight of the workpiece in the housing ensures safe storage even during vertical movement. In addition, a locking device may be used to ensure that the workpiece does not accidentally loosen from the housing.

Grooves are preferably provided in the holder of the workpiece into which the webs of the housing engage. Instead of the webs, any other projections on the housing may also engage into the grooves, and it is also possible to exchange these elements kinematically.

Further advantages, details and features will arise from the following illustration of the invention using several examplary embodiments, while reference is made to the drawings, wherein:

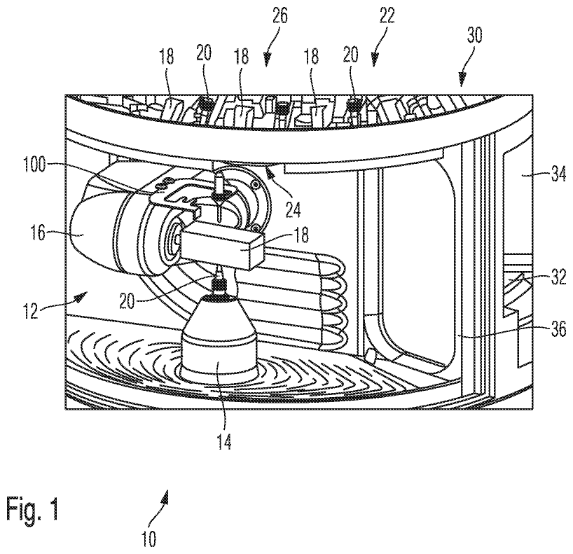

FIG. 1 is a sectional schematic lateral view of a machine tool according to the invention, with partial representation of the workpiece magazine;

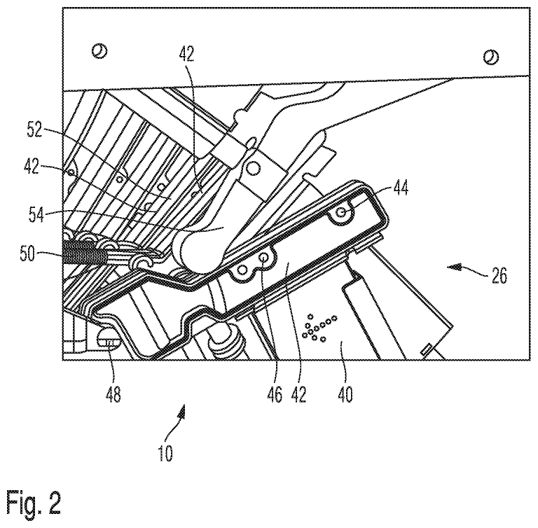

FIG. 2 is a perspective lateral view of a portion of the workpiece magazine;

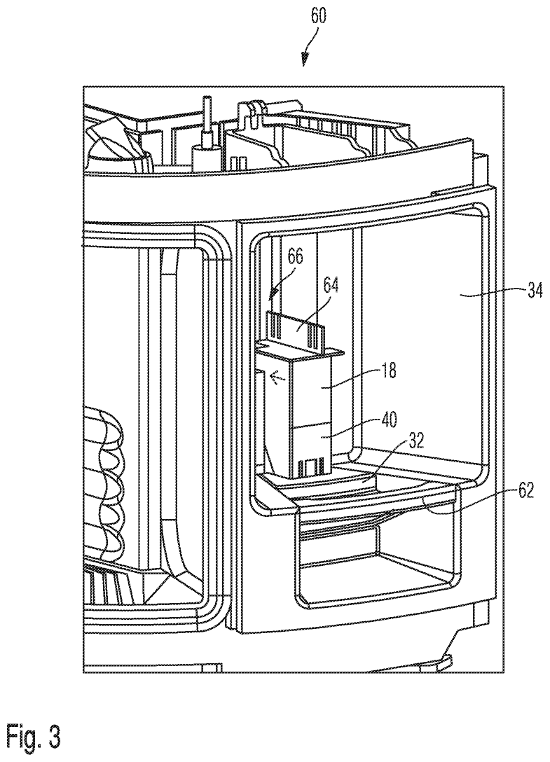

FIG. 3 is a view of a lifting platform according to the invention with workpiece and workpiece housing being inserted;

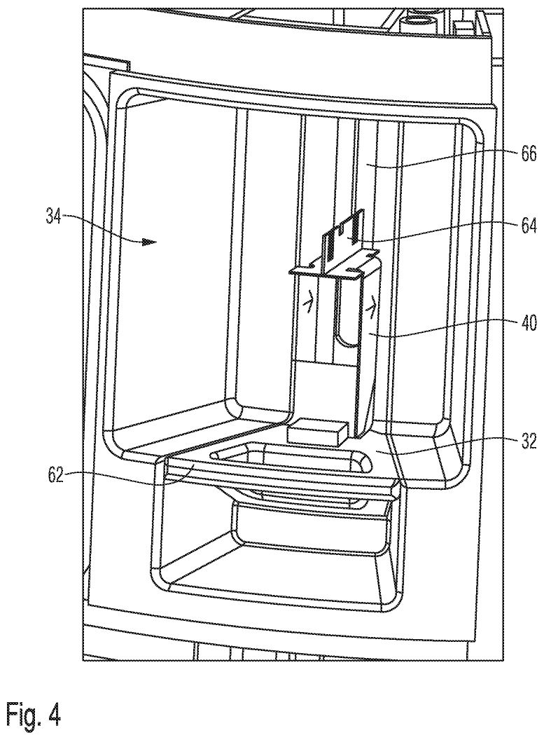

FIG. 4 is a view of another embodiment of the lifting platform with workpiece and workpiece housing being inserted;

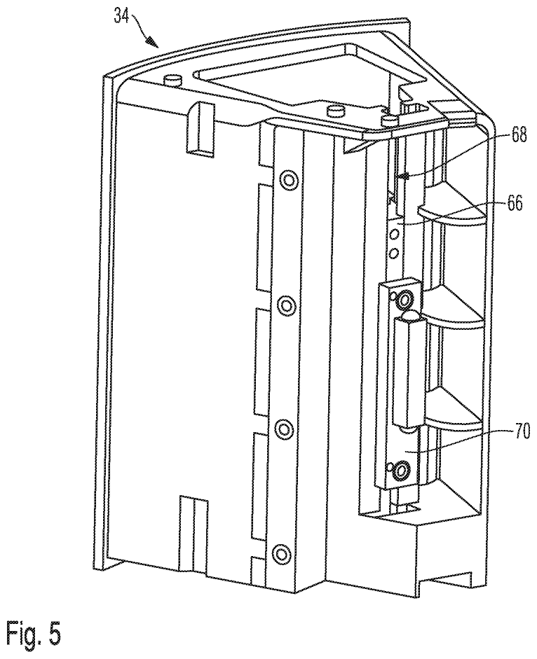

FIG. 5 is a view of the lifting platform according to FIG. 4 from the rear;

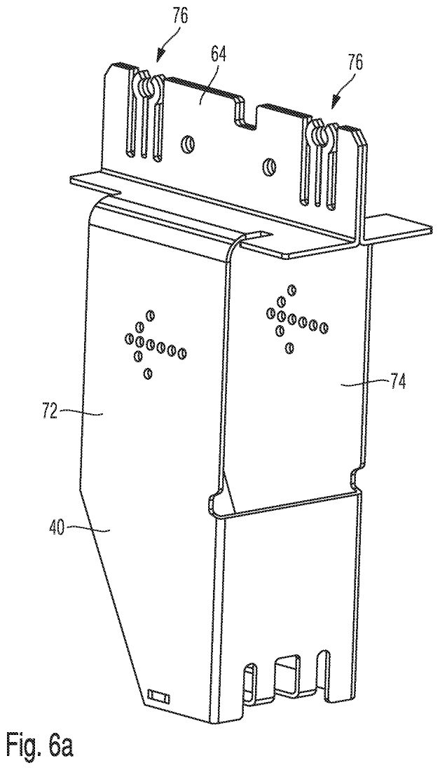

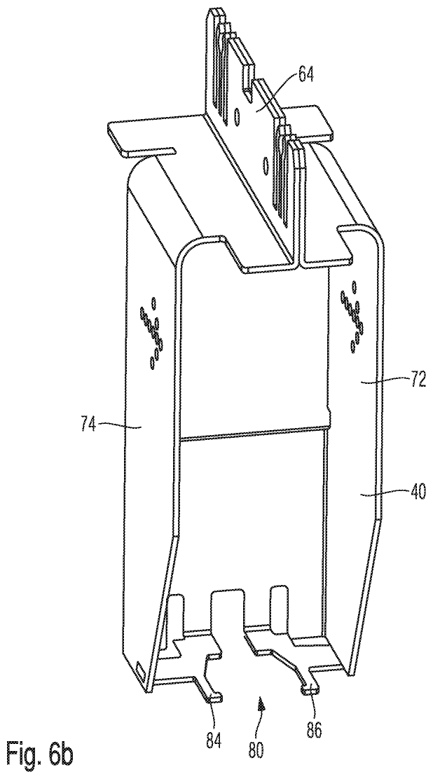

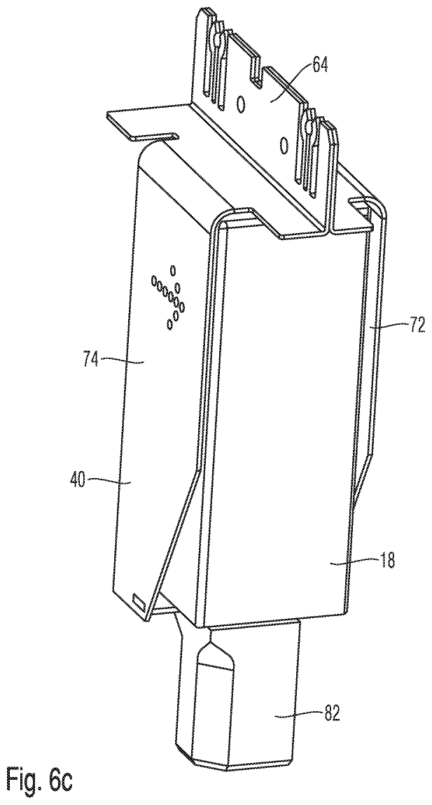

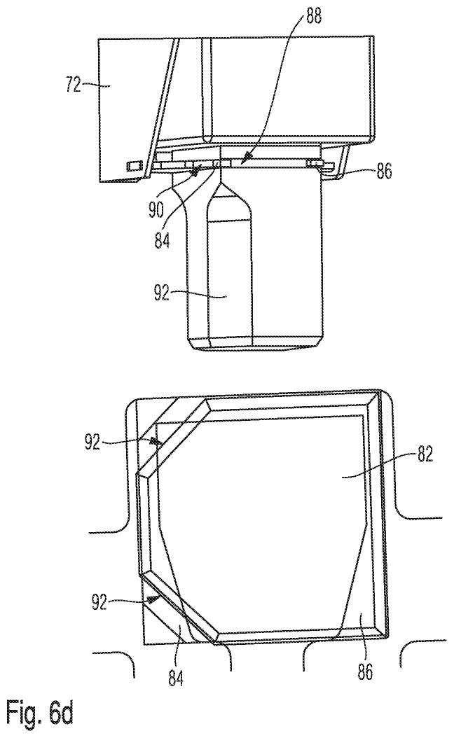

FIG. 6a is a perspective view of a workpiece housing;

FIG. 6b is the workpiece housing of FIG. 6a, but from a different perspective;

FIG. 6c is the workpiece housing of FIG. 6b with workpiece being inserted;

FIG. 6d is detail views of FIG. 6c;

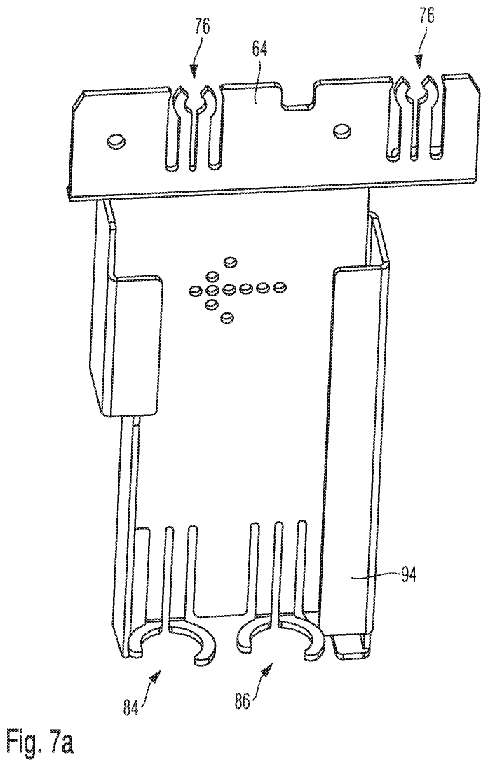

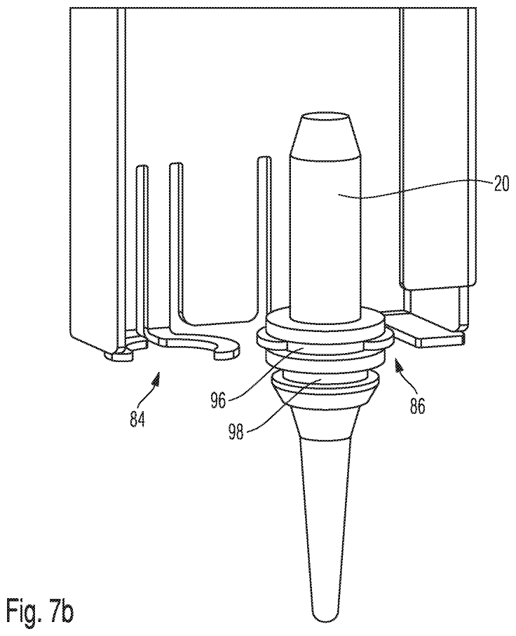

FIG. 7a is a perspective view of a tool housing;

FIG. 7b is a detailed view of FIG. 7a with tool being inserted;

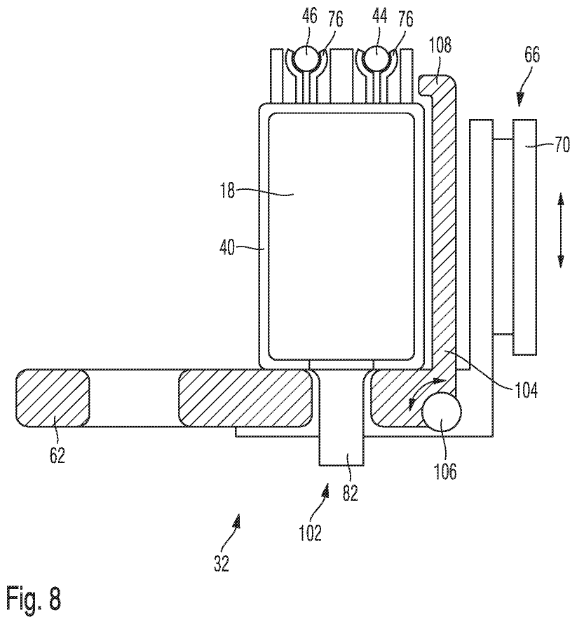

FIG. 8 is a schematic cross-sectional view of another embodiment of a lifting platform according to the invention;

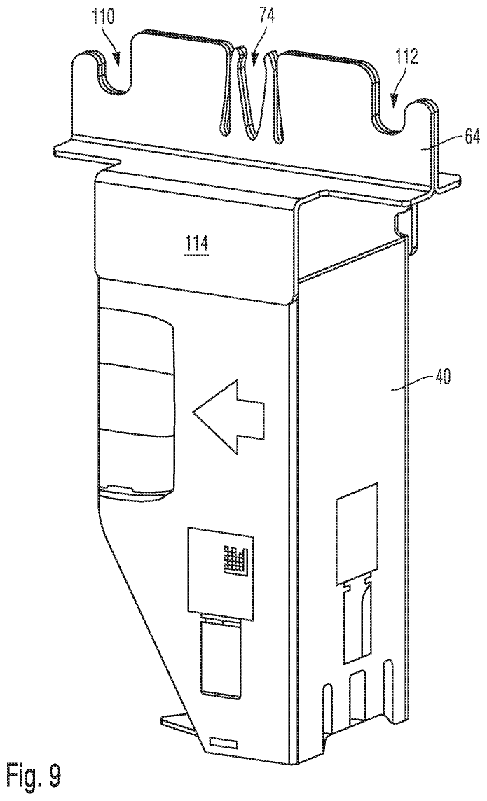

FIG. 9 is a perspective view of another embodiment of a housing for a workpiece according to the invention; and

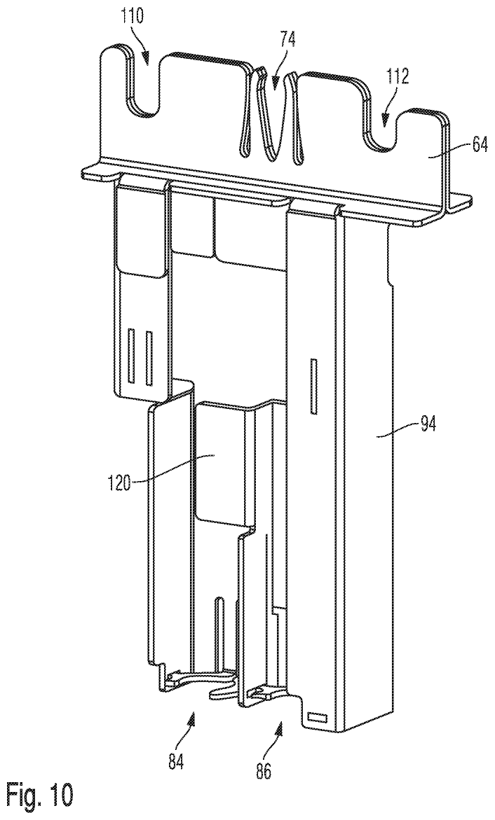

FIG. 10 is a perspective view of another embodiment of a housing for a tool according to the invention.

FIG. 1 shows an embodiment of a machine tool 10 according to invention. In the example shown, the machine tool is designed as a milling machine for dental purposes. It is to be understood that the invention may also be used with any other cutting machine tool, especially compact machine tools, such as grinding machines or turning-grinding machines for the dental industry.

The machine tool 10 comprises a milling chamber 12 in which a tool spindle 14 is operated driven by a spindle motor. A robot arm 16 is capable of feeding a workpiece 18 to the spindle 14 in a suitable manner, wherein the robot arm 16 is mounted in a 5-axis manner and the tool spindle 14 is fixed.

The tool spindle 14 accommodates a tool 20, holding it in its clamping jaws in a manner known per se.

The tool spindle 14 is mounted at the bottom of the milling chamber 12. Opposite the spindle 14, i.e. on the ceiling of the milling chamber 12, a workpiece magazine 22 is mounted. The workpiece magazine 22 extends above the milling chamber 12 and is separated therefrom by the ceiling wall which is not shown. A workpiece may be taken out from or inserted into the magazine 22 at a transfer position 26 of the workpiece magazine 22 through a door 24.

The workpiece magazine 22 is approximately quarter-circular and pivotably mounted, such that any workpiece may be brought into the transfer position 26. In addition, it also accommodates tools 20 between the workpieces 18.

A loading position 30 is also provided, and is provided not directly above the milling chamber 16, but is laterally offset. The loading position 30 allows workpieces and tools to be fed to magazine 22 in the blank state and allows finished workpieces to be taken out therefrom.

A lifting platform 32 is provided below the loading position 30. This is for taking out the tool or workpiece in the lower position of the lifting platform 32.

The lifting platform 32 is movably mounted in a vestibule 34. This is separated from the milling chamber 12 by a partition wall 36.

A detail of the machine tool 10 is shown in FIG. 2. It is the transfer position 26 of the workpiece magazine 22. As can be seen, for example, a workpiece is held in a housing 40, i.e. a workpiece housing, and mounted on a lever 42. For this purpose, the lever 42 has holding elements 44 and 46, which are described in detail below. The lever 42 is pivotably mounted on an axle 48. It is pulled into an upper position 52 by a tension spring 50.

Several levers 42 are shown behind the lever 42, as shown herein, and are shown in the upper position.

zo The lever 42 in the transfer position 26 is swiveled downwards by an actuating element 54 acting against the effect of the spring 50.

Preferably, the lever is swiveled so far that the lever 42 extends essentially horizontally.

In this position, the housing 40 can easily be taken out with the workpiece 18 held therein.

In the upper position, in which the levers 42 extend obliquely upwards at an angle of about 45° and in which the actuating element 54 is not active, the workpiece magazine 22 can be rotated freely. Contrary to this, the rotating position of the workpiece magazine 22 is fixed when a lever 42—and thus the associated housing 40 including the workpiece 18—is to be lowered in the transfer position 26. For this purpose, the actuating element 54 is activated and the workpiece with the housing 40 is lowered so that the robot arm 16 can grasp it more easily.

A corresponding embodiment including an actuating element 54 is also provided for the loading position 60 schematically shown in FIG. 3; an actuating element is also arranged herein, even if this may not be seen from FIG. 3.

The loading position 60 is located above the vestibule 34. The lifting platform 32 is arranged at this position, namely in a vertically movable manner. In the state shown in

FIG. 3, the lifting platform 32 carries a housing 40, which is loaded with a workpiece 18. For details concerning the embodiment of the housing 40, reference is to be made to FIGS. 6a to 6d.

The lifting platform 32 has a grip handle 62 which extends, like a bow, essentially horizontally and transversely at the front, i.e. at the front of the vestibule 34. Manual operation moves the lifting platform 32 from the lower position shown in FIG. 3 to an upper position. In the upper position the lifting platform 32 is close to the loading position 60 of the workpiece magazine 22. The housing 40, on its upper side, has a web 64 zo extending from the rear to the front, on which latching tongues are formed, as shown in

FIG. 6a. These locking tongues are suitable for latching into the holding elements 44 of the workpiece magazine 22, and holding the housing 40 together with the workpiece 18 as soon as the lifting platform 32 is brought into the upper position via the gripping handle 62.

To move the workpiece 18 into the milling chamber 12, the associated lever 42 is now lifted in the loading position by the effect of the spring 50 by releasing the actuating element 54. The respective workpiece in the housing 40 is then swiveled by the workpiece magazine 22 into the transfer position 26, where it is lowered again so that the robot arm 16 can grasp a downward protruding holder of the workpiece and take out the workpiece from the housing 40.

After finishing, the workpiece is transported in the reverse direction, with the lever 42 of the workpiece magazine 22 being lowered and raised accordingly.

The lifting platform 32 can also be lowered in the meantime in order to allow another workpiece accommodated in a housing to be fed into the workpiece magazine 22.

In FIG. 4 the vestibule 34 is shown in a perspective different from that of FIG. 3. Herein, the housing 40 is not equipped with a workpiece. The lifting platform 32 is vertically guided on a sliding guide 66.

A rear view of the vestibule 34 is shown in FIG. 5. The sliding guide 66 has a slot 68 which extends vertically on the rear wall of the vestibule 34. This is crossed by a web which is attached to the rear of the lifting platform 32. A counter plate 70 is attached to the web and is slightly wider than the slot 68. The play of the counter plate 70 against the rear wall of the vestibule 34 is such that the lifting platform 32 is self-retaining so that it is maintained at the height as adjusted by the user.

It is to be understood that instead of the guide shown herein, any other guides are also possible, for example with an adjustable brake for adjusting the displacement force.

FIG. 6a shows a perspective view of a housing 40. The housing has closed lateral walls 72 and 74. The unit consisting of the workpiece and the housing may then be grasped easily therewith. The web 64 is equipped with two spring tongue arrangements 76, which are to encompass the holding elements 44 and 46 of the workpiece magazine.

A perspective view of the housing 40 is shown in FIG. 6b from another angle. The housing 40 has an open rear wall and a recess 80 at the bottom, which is designed to allow a holder 82 (FIG. 6c) of a workpiece 18 to pass therethrough. The recess 80 is limited by slightly resilient latching tongues 84 and 86, which project slightly inwards at the ends so that they can securely hold the holder 82.

As shown in FIG. 6c, the workpiece 18 is surrounded by the housing 40 on at least two sides when inserted. Loading is done horizontally, via the open rear wall of the housing. The holder 82 of the workpiece 18 protrudes downwards from the housing. FIG. 6d shows that the holder 82 has a groove 88 into which the latching tongues 84 and 86 may engage. With respect to the lateral walls 72 and 74, the latching tongues 84 and 86 form projections 90 facing inwards.

The holder 82 has an essentially square cross-section. However, it is provided with two inclined surfaces 92 to be unequivocally supported on the robot arm 16, which surfaces 92 extend at an angle of about 45° to the adjacent surfaces.

A housing 94 for tools is shown in FIG. 7a. This housing also has a web 64 with spring tongue arrangements 76 at the top center. Two latching switch arrangements 84 and 86 are located below, each of which serves to hold one tool 20. This is illustrated in FIG. 7b.

Tool 20 has a collar 97 between its shank 95 and its working tip 99. An upper groove 96 is formed on the collar, into which groove the latching tongue arrangement 86 engages. In addition, a lower groove 98 is provided, which can be grasped by a gripper 100 of the robot arm 16 (see FIG. 1), in order to move the tool 20 out of the position in the latching zo tongue 86 by lateral movement.

For the provision in the tool spindle 14, the robot arm 16 is turned by 180° so that the shank of tool 20 can be inserted into the chuck.

A modified embodiment of the lifting platform 32 is shown in FIG. 8. It can be seen that the holder 82 of the workpiece 18 passes through a recess 102 of the lifting platform 32 when the housing 40 including the workpiece 18 is placed thereon.

In this embodiment, a pivoting element 104 is essentially L-shaped and mounted on an axis 106 on the lifting platform 32 for the rest. This swivel element 104 ends at the bottom outside in the grip handle 62 and at the top in a grasp claw 108, which is dimensioned such that when lowering the grip handle 62 engages across the housing 40 and when lowering it also pulls the housing 40 downwards.

This allows the latching connection between spring tongue assemblies 76 and the holding elements 44 and 46 of the magazine 22 to be released to move the lifting platform 32 together with workpiece 18 from the upper position to the lower position.

Another embodiment of a workpiece housing 40 according to the invention is shown in FIG. 9. In this embodiment, holding elements to be mounted in grooves on a holder 82 of a workpiece 20 are provided as illustrated in FIG. 6b below, which holding elements end in latching tongues 84 and 86.

The difference to the embodiment of the workpiece housing 40 of FIGS. 6a to 6d is the type of suspension in the magazine 22.

A web 64 is provided, which extends across the entire upper side of the housing. The web 64 has a locking tongue 74 in the center thereof, which is for mounting to a corresponding holding element of the magazine 22.

zo At the back and front, the web 64 has two grooves 110, 112. The grooves 110 and 112 are each for engaging transverse pins at the respective position of the magazine 22. In this respect, the magazine 22 is provided with positions for the workpiece housings 40, but also with positions for the tool housings 94.

The arrangement of the grooves 110, 112 is different in these two housings, in that there is a coding.

The housings 40 and 94 are made of sheet metal and comprising stiffeners 114, increasing the precision of the guidance. Sheet metal has the advantage of having adjustable stiffness and elasticity depending on the design. It is to be understood that any other materials may also be used instead for providing a housing according to the invention; an example for this is glass-fiber reinforced plastic or realization of the housing using injection molding or die casting.

FIG. 10 shows a workpiece housing 94. According to FIG. 7a and FIG. 7b, the workpiece housing 94 has latching tongues 84 and 86 for holding a total of 2 workpieces at their collars. The mounting positions for the two tools not shown herein have height stops on their upper side, wherein one of which height stops 120 is shown in FIG. 10.

1. A machine tool comprising
a workpiece magazine for receiving workpieces, optionally with the aid of a housing,
wherein the workpiece magazine (22) is movably mounted with respect to the machine tool (10) and has a loading position (30) for loading a new workpiece (18) into the magazine (22),
wherein the housing (40) is provided for each workpiece (18), which housing at least partially accommodates the workpiece (18), and/or wherein a lifting platform (32), is arranged adjacent to the loading position (30) and on or at which the housing (40) may be accommodated and moved together with the workpiece (18).

2. A machine tool comprising
a tool magazine for receiving tools, optionally with the aid of a housing,
wherein the tool magazine (22) is movably mounted with respect to the machine tool (10) and has a loading position (30) for loading a new tool (20) into the magazine (22),
wherein the housing (94) is provided for each tool (20), which at least partially accommodates the tool (20), and/or
wherein a lifting platform (32) which is arranged adjacent to the loading position (30) and on or at which the housing (94) may be accommodated and moved together with the tool (20).

3. The machine tool according to claim 1,
wherein the lifting platform (32) is substantially vertically movable and is movable transversely to the direction of movement of the magazine (22), which is configured as a linear magazine, a circular or semicircular round magazine.

4. The machine tool according to claim 1,
wherein the lifting platform (32) comprises a grip handle (62) for the manual movement of the lifting platform (32) substantially vertically, or a drive for the mechanical movement substantially vertically and/or
wherein the lifting platform (32) comprises a vertical sliding guide (66) extending parallel to an axis of rotation of the workpiece magazine (22),

5. The machine tool according to claim 1,
wherein, the workpiece (18) is a dental workpiece which is a blank and is taken out as a dental restoration from the machine tool (10) via the same loading position (30) in the magazine (22) and via the lifting platform (32) and/or
wherein a tool (20) is provided as a dental tool comprising a milling tool, a grinding tool, or a rotary grinding tool which is loaded to a tool spindle (14) via the magazine (22) and via a robot arm (16) and is taken out from the machine tool (10) for tool changing via the loading position (30) in the magazine (22) and via the lifting platform (32) of the machine tool (10).

6. The machine tool according to claim 1,
wherein the workpiece magazine (22) is simultaneously designed as a tool magazine which, at predetermined rotational positions, accommodates workpieces (18) with associated housings (40) and, at other rotational positions, tools (20), via receiving housings (94).

7. The machine tool according to claim 1,
wherein at each rotational position of the magazine (22) at least one holding element (44, 46) is formed for a latchable accommodation of a housing (40, 94).

8. The machine tool according to claim 7,
wherein each housing (40, 94), on a side of the housing (40, 94) facing the receiving position of the magazine (22), has at least one latching tongue (84, 86) for engaging in a retaining element (44, 46) connected to the magazine (22), the side of the housing being the upper side of the housing (40, 94).

9. The machine tool according to claim 1,
wherein each workpiece (18) and/or one or more tools (20) has a groove or recess (80) having a the dimension which is adapted to projections of the housing (40) and into which groove or recess (80) projections of the housing (40) can be inserted.

10. The machine tool according to claim 9,
wherein, for mounting the workpiece (18) and/or the tool (20) in the housing (40) at a lower end of the housing, latching tongues (84, 86) are formed on the projections, which latching tongues at least partially encompass a holder (82) of the workpiece (18) and/or the tool (20), in the groove thereof.

11. The machine tool according to claim 1,
wherein a part of the workpiece (18) and/or a part of a tool (20), protrude from the housing (40), and wherein the grooves are formed on a collar (82, 86) of the workpiece and/or tool.

12. The machine tool according to claim 11,
wherein, in a transfer position of the workpiece magazine (22), the collar (82, 86) projects from the housing (40) such that it can be grasped by a robot arm (16) of the machine tool (10).

13. The machine tool according to claim 1,
wherein the workpiece (18) and/or a tool (20) is slidably mounted in the housing (40), and can be taken out manually or via a robot arm (16) by lateral displacement.

14. The machine tool according to claim 1,
wherein the magazine (22) is arranged at a top of the machine tool (10) and opposite a milling spindle (14), and/or
wherein the housings (40, 94) comprises latching tongues (84, 86) and are suspended on holding elements (44, 46) of the magazine (22).

15. The machine tool according to claim 1,
wherein, when the lifting platform (32) is raised into the loading position (30), the housing (40, 94) placed on the lifting platform (32) remains suspended on the respective holding element (44, 46) of the magazine (22) when the at least one latching tongue (84, 86) thereof latches in place, even if the lifting platform (32) is lowered.

16. The machine tool according to claim 1,
wherein a holder (82) of the workpiece (18) and/or a working tip of a tool (20) is suspended from the housing (40, 94) and is accommodated in a recess (80) of the lifting platform (32) when the housing (40) including the workpiece (18) is placed on the lifting platform (32).

17. The machine tool according to claim 1,
wherein the housing (40, 94) encompasses the workpiece (18) and/or a tool (20) so far that it can be taken out from the lifting platform (32) only together with the housing (40).

18. The machine tool according to claim 1,
wherein two mutually opposite side walls of the housing (40) are provided, which flatly extend and on which the housing (40) may be grasped, and
wherein the housing (40) encompasses the workpiece (18) such that the workpiece (18) is protected with respect to a ceramic portion thereof.

19. A system comprising
a machine tool and
a workpiece comprising a workpiece magazine for receiving workpieces optionally with the aid of a housing,
wherein the workpiece magazine (22) is movably mounted with respect to the machine tool (10) and has a loading position (30) for loading a new workpiece (18) into the magazine (22),
wherein a housing (40) is provided for each workpiece (18), which housing at least partially accommodates the workpiece (18), and/or
wherein a lifting platform (32) is arranged adjacent to the loading position (30) and on or at which the housing (40) may be accommodated and moved together with the workpiece (18).

20. The system according to claim 19,
wherein the workpiece (18) comprises a dental material which can be milled or ground or machined.

21. The machine tool according to claim 1,
wherein the machine tool is a milling machine for dental purposes, and
wherein the housing (40) comprises a partial housing for each workpiece (18).

22. The machine tool according to claim 2,
wherein the machine tool is a milling machine for dental purposes, and
wherein the housing (40) comprises a partial housing for each tool (20).
